(19) United States
(12) Patent Application Publication
(10) Pub. No.: US 2026/0118232 A1
(43) Pub. Date: Apr. 30, 2026

(54) TISSUE AND BIOPSY CASSETTES IN HISTOLOGY

(71) Applicant: GANGDONG GROUP CO., LTD., Eumseong-gun (KR)

(72) Inventors: Yongwook JEONG, Incheon (KR); Sanghoon KANG, Seoul (KR); Dongkwan YU, Seongnam-si (KR)

(73) Assignee: GANGDONG GROUP CO., LTD., Eumseong-gun (KR)

(21) Appl. No.: 18/280,763

(22) PCT Filed: Feb. 24, 2023
(86) PCT No.: PCT/KR2023/002646

§ 371 Date: Sep. 26, 2025

(30) Foreign Application Priority Data
Feb. 20, 2023 (KR) 10-2023-0022274

(51) Int. Cl. G01N 1/36

(52) U.S. Cl. CPC G01N 1/36; G01N 2001/366

(57) ABSTRACT

Disclosed is a cassette for histological examination, the cassette including: a body part accommodating a tissue sample and having at least one through hole formed therein; and an opening/closing part coupled to one side of the body part to open and close an open upper side of the body part, and having at least one through hole formed therein.

### FIELD

The present disclosure relates to a cassette for histological examination, and more specifically, a cassette for histological examination, which is designed to store tissues for histological examination and prevent detachment of the tissues from the cassette's internal space during storage and histological-chemical processing, while fully resisting a chemical action of histological reagents.

### RELATED ART

In general, a method for examining tissue involves several steps. The steps include: a processing step of infiltrating paraffin into tissue for absorption within the tissue after placing the tissue intended for examination into a cassette and subjecting them to chemical processing (Dehydration & Clearing) with histological reagents for the examination; an embedding step of solidifying the tissue along with the paraffin to enable cutting to a thickness suitable for histological examination; a sectioning step of fixing the tissue, solidified together with paraffin on the back of the cassette, to a microtome to form tissue sections of 2-10 μm thickness while cutting the solidified paraffin; and an examination step of slicing the processed and sectioned the tissue into slides, subjecting the slides to staining procedures, and then interpreting the results.

In particular, during the embedding step of creating tissue paraffin blocks, the tissue paraffin blocks may be produced by pouring liquid paraffin into embedding molds, placing processed tissue into the molds, and securing a cassette in the embedding molds before solidifying.

In addition, a conventional cassette is composed of a main body into which tissue is inserted, and an opening/closing part that opens and closes the main body.

Furthermore, when tissue inserted within the main body floats and moves inside the cassette during chemical processing with histological reagents, the tissue could detach from the main body through a gap from the opening/closing part when the opening/closing part is opened and closed, thereby leading to potential damage or loss of the tissue.

### DETAILED DESCRIPTION

### Problems to be Solved

An objective of the present disclosure is to provide a cassette for histological examination, the cassette capable of preventing damage or loss of tissue by preventing the tissue from detaching in one direction (the direction in which a body part and an opening/closing part are coupled) when the cassette for histological examination according to the present disclosure is shaken by a surrounding environment during storage and histological and chemical processing or shaken due to a user's force during the opening and closing process of the cassette.

Objectives of the present disclosure are not limited to the objective mentioned above, and other objectives not mentioned may be clearly understood by those skilled in the art from the description below.

### Means to Solve the Problems

In one aspect of the present disclosure, there is provided a cassette for histological examination, the cassette including: a body part accommodating a tissue sample and having at least one through hole formed therein; and an opening/closing part coupled to one side of the body part to open and close an open upper side of the body part, and having at least one through hole formed therein.

The body part may include: a first inclined surface formed to be inclined downward from an upper surface on one side; a vertical surface formed to be vertically downward from the first inclined surface; a second inclined surface formed to be inclined downward from the vertical surface; a horizontal surface formed to be horizontally downward from the second slope; a third inclined surface formed to be inclined downward from the horizontal surface; and a seating surface having seating grooves formed in both sides of the body, into which seating protrusions of the opening/closing part are inserted.

The opening/closing part may include: the seating protrusions to be inserted into the seating grooves; a first barrier formed in the shape of a long plate extending toward one side of the opening/closing part, wherein upon opening of the opening/closing part, the first barrier is positioned above the horizontal surface, thereby preventing tissues from moving through a top of the horizontal surface in a direction from the third inclined surface to the second inclined surface; and a second barrier formed in the shape of a long plate positioned between the seating protrusions and protruding in a direction perpendicular to the upper surface of the opening/closing part, wherein upon opening of the opening/closing part, the second barrier is positioned above the upper surface of the horizontal surface, thereby preventing tissues from moving through the top of the horizontal surface in a direction from the third inclined surface to the second inclined surface.

The body part may include: at least one coupling groove coupled to the opening/closing part on the other side opposite to the one side; and a first step formed in an edge other than an edge on one side among edges.

The opening/closing part may include: at least one coupling protrusion coupled to the coupling groove; and a second step continuously protruding from a position corresponding to the first step so as to be seated on the first step.

### Advantageous Effects

As such, there is an advantage of preventing damage or loss of tissue by preventing the tissue from detaching in one direction (the direction in which a body part and an opening/closing part are coupled) when a cassette for histological examination according to the present disclosure is shaken by a surrounding environment during storage and histological and chemical processing or shaken due to a user's force during the opening and closing process of the cassette.

The effects of the present disclosure are not limited to the effects mentioned above, and other effects not mentioned will be clearly understood by those skilled in the art from the description below.

### BRIEF DESCRIPTION OF THE DRAWINGS

FIGS. 1 and 2 are views showing a cassette for histological examination according to an embodiment of the present disclosure.

FIGS. 3 and 4 are views showing an open state of a cassette for histological examination according to an embodiment of the present disclosure.

FIG. 5 is a view showing a main body of a cassette for histological examination according to an embodiment of the present disclosure.

FIG. 6 is a view showing an opening/closing part of a cassette for histological examination according to an embodiment of the present disclosure.

### DESCRIPTION OF EXEMPLARY EMBODIMENTS

In one aspect of the present disclosure, there is provided a cassette for histological examination, the cassette including: a body part accommodating a tissue sample and having at least one through hole formed therein; and an opening/closing part coupled to one side of the body part to open and close an open upper side of the body part, and having at least one through hole formed therein.

The body part may include: a first inclined surface formed to be inclined downward from an upper surface on one side; a vertical surface formed to be vertically downward from the first inclined surface; a second inclined surface formed to be inclined downward from the vertical surface; a horizontal surface formed to be horizontally downward from the second slope; a third inclined surface formed to be inclined downward from the horizontal surface; and a seating surface having seating grooves formed in both sides of the body, into which seating protrusions of the opening/closing part are inserted.

The opening/closing part may include: the seating protrusions to be inserted into the seating grooves; a first barrier formed in the shape of a long plate extending toward one side of the opening/closing part, wherein upon opening of the opening/closing part, the first barrier is positioned above the horizontal surface, thereby preventing tissues from moving through a top of the horizontal surface in a direction from the third inclined surface to the second inclined surface; and a second barrier formed in the shape of a long plate positioned between the seating protrusions and protruding in a direction perpendicular to the upper surface of the opening/closing part, wherein upon opening of the opening/closing part, the second barrier is positioned above the upper surface of the horizontal surface, thereby preventing tissues from moving through the top of the horizontal surface in a direction from the third inclined surface to the second inclined surface.

The body part may include: at least one coupling groove coupled to the opening/closing part on the other side opposite to the one side; and a first step formed in an edge other than an edge on one side among edges.

The opening/closing part may include: at least one coupling protrusion coupled to the coupling groove; and a second step continuously protruding from a position corresponding to the first step so as to be seated on the first step.

The present disclosure may be variously changed and may have various embodiments, and specific embodiments will be described in detail below with reference to the attached drawings.

However, it should be understood that those embodiments are not intended to limit the present disclosure to specific disclosure forms and they include all changes, equivalents or modifications included in the spirit and scope of the present disclosure. In the following description of the present disclosure, the same reference numerals are used to designate the same or similar elements throughout the drawings.

When a component is said to be “connected” or “connected” to another component, it is understood that it may be directly connected to or connected to the other component, but that other components may exist in between. On the other hand, when it is mentioned that a component is “directly connected” or “directly connected” to another component, it should be understood that there are no other components in between.

The terms used in this application are only used to describe specific embodiments and are not intended to limit the invention. Singular expressions include plural expressions unless the context clearly dictates otherwise. In this application, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof.

Hereinafter, embodiments of the present disclosure will be described with reference to the attached drawings. The same symbols shown in each drawing represent the same members. In describing the present disclosure, detailed descriptions of related known functions or configurations are omitted in order to not obscure the gist of the present disclosure.

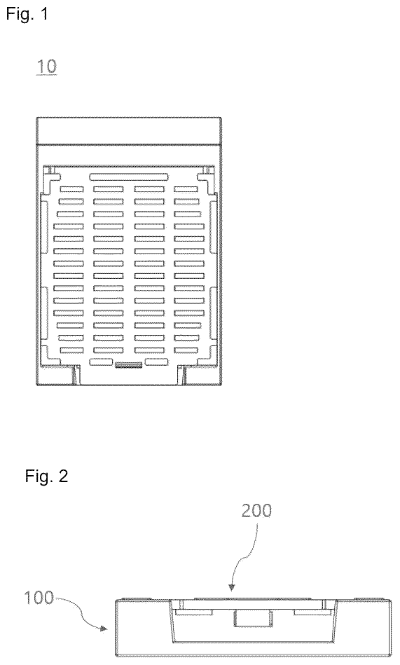

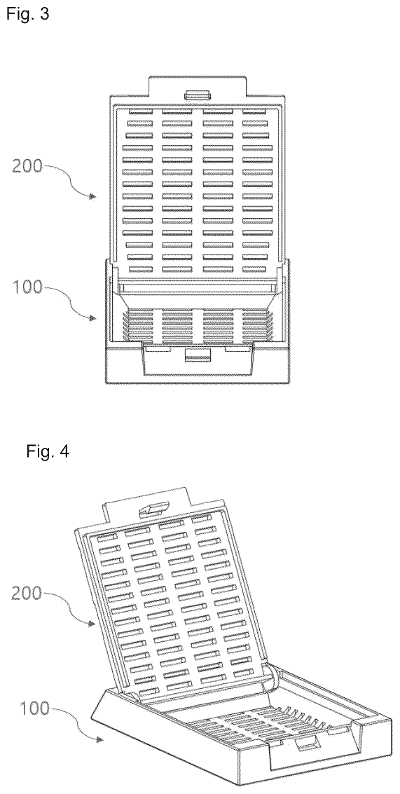

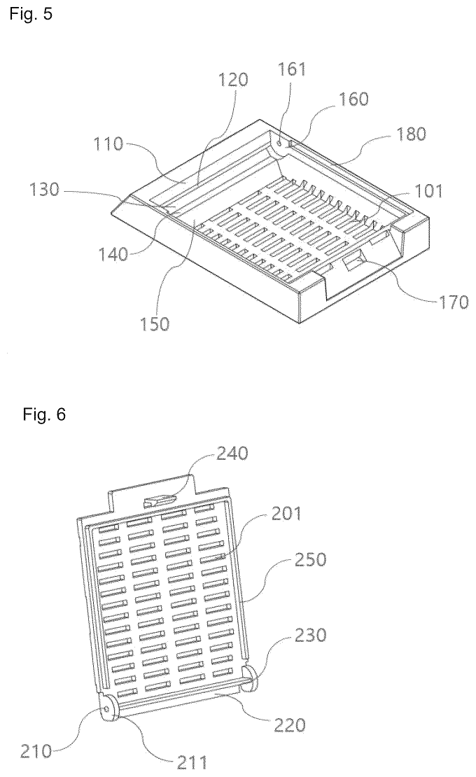

FIGS. 1 and 2 are views showing a cassette for histological examination according to an embodiment of the present disclosure, and FIGS. 3 and 4 are views showing the cassette for histological examination in an open state according to an embodiment of the present disclosure. FIG. 5 is a view showing the main body of a cassette for histological examination according to an embodiment of the present disclosure, and FIG. 6 is a view showing an opening/closing part of a cassette for histological examination according to an embodiment of the present disclosure.

Referring to FIGS. 1 to 6, a cassette for histological examination 10 is composed of a body part 100 and an opening/closing part 200.

The body part 100 has a receiving space in a rectangular parallelepiped shape, and at least one through hole 101 is formed on one side of the receiving space. However, it is not limited to the rectangular parallelepiped shape of the body part 100. In addition, the shape of the through hole 101 may be replaced with various shapes.

In addition, for example, tissues may be inserted into the receiving space of the body part 100, or only the tissues itself may be inserted.

In addition, the body part 100 may include a first inclined surface 110, a vertical surface 120, a second inclined surface 130, a horizontal surface 140, a third inclined surface 150, and a seating surface 160.

The first inclined surface 110 may be formed to be inclined downward from the upper surface of the body part 100 on one side.

The vertical surface 120 may be formed to be vertically downward from the first inclined surface 110.

The second inclined surface 130 may be formed to be inclined downward from the vertical surface 120.

The horizontal surface 140 may be formed to be horizontally downward from the second inclined surface 130.

The third inclined surface 150 may be formed to be inclined downward from the horizontal surface 140.

The seating surface 160 may have seating grooves 161 formed on both sides of the body 100 into which seating protrusions 210 of the opening/closing part 200 are inserted.

When the opening/closing part 200 is opened from the open upper side of the body part 100, the upper surface of the opening/closing part 200 may be supported on one or more of the first inclined surface 110, the second inclined surface 130 and the third inclined surface 150 to maintain a tilted position.

In addition, the body part 100 may include at least one coupling groove 170 formed on the other side opposite to one side to be coupled to the opening/closing part 200, and a first step 180 formed in an edge excluding one side edge among edges.

For example, the first step 180 may be formed only on both lateral sides of the body part 100 other, excluding one side and the other side opposite to the other side.

The coupling groove 170 may be formed on an inclined surface on the other side of the body part 100. As a result, when the opening/closing part 200 is closed in the body 100, an empty space may be formed between the other side of the body 110 and the other side of the opening/closing part 200, so that when a user opens the opening/closing part 200 from the body part 100, a part of the user's fingernail can be inserted into the empty space, making it easy to lift and open the opening/closing part 200 toward one side of the body part 100.

Meanwhile, at a lower edge of the receiving space of the body part 100, a surface may be formed with a predetermined slope to prevent tissues from shaking when the tissue is inserted.

The opening/closing part 200 is coupled to one side of the body part 100 to open and close the open upper side of the body part 100, and has at least one through hole 201 formed therein.

In this case, the opening/closing part 200 may be coupled in a direction where one side of the body part 100, such as the first inclined surface 110, the vertical surface 120, the second inclined surface 130, the horizontal surface 140, the third inclined surface 150, and the seating surface 160, is formed.

In addition, the opening/closing part 200 may include the seating protrusions 210, a first barrier 220, and a second barrier 230.

The seating protrusions 210 may be inserted into the seating grooves 161.

More specifically, the seating groove 161 may be formed by denting the seating surface 160 located on each of two inner surfaces located on one side of the body part 100.

Meanwhile, the seating protrusions 210 may be formed to protrude from the seating surface 211 located on each of the two outer surfaces of the opening/closing part 200.

In this case, two seating protrusions 210 may be inserted into two seating grooves 161 to be coupled thereto.

In addition, after coupled to each other, the two seating protrusions 210 and the two seating grooves 161 may be positioned on the same imaginary straight line and able to be rotated about the imaginary straight line as the axis of rotation.

The first barrier 220 may be formed in the shape of a long plate extending toward one side of the opening/closing part 200, and when the opening/closing part 200 is open, the first barrier 220 may be positioned above the horizontal surface 140, thereby preventing tissues from moving through the top of the horizontal surface 140 in a direction from the third inclined surface 150 to the second inclined surface 130.

In addition, when extending to one side of the opening/closing part 200, the first barrier 220 may extend parallel to an upper surface of the opening/closing part 200.

The second barrier 230 may be formed in the shape of a long plate positioned between the seating protrusions 210 and protruding in a direction perpendicular to the upper surface of the opening/closing part 200, and when the opening/closing part 200 is opened, the second barrier 230 may be positioned above the upper surface of the horizontal surface 140, thereby preventing tissues from moving through the top of the horizontal surface 140 in a direction from the third inclined surface 150 to the second inclined surface 130.

In addition, the opening/closing part 200 may include at least one coupling protrusion 240 coupled to the coupling groove 170. In this case, a ring (not shown) may be formed between the coupling protrusion 240 and the coupling groove 170 to secure the coupled state.

In addition, the opening/closing part 200 may include a second step 250 that continuously protrudes at a position corresponding to the first step 180 so as to be seated on the first step 180.

Here, the second step 250 may be formed on both edges of the opening/closing part 200, and may be seated on the first step 180 formed on both sides of the body part 100.

Specifically, the first step 180 may be formed in an “L” shape, and the second step 250 may be formed in an “┐” shape, so that the second step 250 can be seated on the first step 180.

Meanwhile, in the upper surface where the through hole 201) of the opening/closing part 200 is formed, a magnifying lens (microscope) may be formed to enable the enlargement of tissues. In this case, the through hole 201 of the opening/closing part 200 may be formed in the upper surface other than a portion where the magnifying lens is formed.

Therefore, it is possible to prevent damage or loss of tissue by preventing the tissue from detaching in one direction (the direction in which a body part and an opening/closing part are coupled) when the cassette for histological examination according to the present disclosure is shaken by a surrounding environment during storage and histological and chemical processing or shaken due to a user's force during the opening and closing process of the cassette.

Optimal embodiments of the present disclosure have been disclosed in the drawings and the specification. Although specific terms have been used in the present specification, these are merely intended to describe the present disclosure and are not intended to limit the meanings thereof or the scope of the present disclosure described in the accompanying claims. Thus, those skilled in the art will appreciate that various modifications and other equivalent embodiments are possible from the embodiments. Therefore, the technical scope of the present disclosure should be defined by the technical spirit of the claims.

### DESCRIPTION OF REFERENCE NUMBERS

10: cassette for histological examination
100: body part
101: through hole
110: first inclined surface
120: vertical surface
130: second inclined surface
140: horizontal surface
150: third inclined surface
160: seating surface
161: seating grooves
170: coupling groove
180: first step
200: opening/closing part
201: through hole
210: seating protrusions
211: seating surface
220: first barrier
230: second barrier
240: coupling protrusion
250: second step

What is claimed is:

1. A cassette for histological examination, the cassette comprising:
a body part accommodating a tissue sample and having at least one through hole formed therein; and
an opening/closing part coupled to one side of the body part to open and close an open upper side of the body part, and having at least one through hole formed therein.

2. The cassette of claim 1, wherein the body part comprises:
a first inclined surface formed to be inclined downward from an upper surface on one side;
a vertical surface formed to be vertically downward from the first inclined surface;
a second inclined surface formed to be inclined downward from the vertical surface;
a horizontal surface formed to be horizontally downward from the second slope;
a third inclined surface formed to be inclined downward from the horizontal surface; and
a seating surface having seating grooves formed in both sides of the body, into which seating protrusions of the opening/closing part are inserted.

3. The cassette of claim 2, wherein the opening/closing part comprises:
the seating protrusions to be inserted into the seating grooves;
a first barrier formed in the shape of a long plate extending toward one side of the opening/closing part, wherein upon opening of the opening/closing part, the first barrier is positioned above the horizontal surface, thereby preventing tissues from moving through a top of the horizontal surface in a direction from the third inclined surface to the second inclined surface; and
a second barrier formed in the shape of a long plate positioned between the seating protrusions and protruding in a direction perpendicular to the upper surface of the opening/closing part, wherein upon opening of the opening/closing part, the second barrier is positioned above the upper surface of the horizontal surface, thereby preventing tissues from moving through the top of the horizontal surface in a direction from the third inclined surface to the second inclined surface.

4. The cassette of claim 1, wherein the body part comprises:
at least one coupling groove coupled to the opening/closing part on the other side opposite to the one side; and
a first step formed in an edge other than an edge on one side among edges.

5. The cassette of claim 4, wherein the opening/closing part comprises:
at least one coupling protrusion coupled to the coupling groove; and
a second step continuously protruding from a position corresponding to the first step so as to be seated on the first step.
